(19) United States
(12) Patent Application Publication
(10) Pub. No.: US 2009/0014226 A1
(43) Pub. Date: Jan. 15, 2009

(54) Torque Differential Modification of a Non-Driven Axle

(75) Inventors: Paul A. Grougan, Novi, MI (US); Edmund F. Gaffney, White Lake, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/776,014

(22) Filed: Jul. 11, 2007

(51) Int. Cl. B60K 28/16

(52) U.S. Cl. 180/197

(57) ABSTRACT

Apparatus and methods are provided for modifying a torque differential between the road wheels of a non-driven axle. One apparatus includes, but is not limited to, two non-driven shafts and a torque transfer modulator coupling the two non-driven shafts. The torque transfer modulator is configured to modify the torque differential between the two non-driven shafts. A motor vehicle includes, but is not limited to, the apparatus coupling left and right road wheels, a sensor for detecting a left turn and/or right turn, and a controller. The controller is configured to transmit an actuating signal to the torque transfer modulator in response to the turn. One method includes, but is not limited to, detecting a driving condition in a motor vehicle, subtracting an amount of torque from a first non-driven road wheel, and adding the amount of torque to a second non-driven road wheel in response to detecting the driving condition.

### TECHNICAL FIELD

The present invention generally relates to motor vehicles, and more particularly relates to modifying the torque differential between the road wheels of a non-driven axle.

### BACKGROUND OF THE INVENTION

There are several compensation techniques for reducing the effects of a motor vehicle understeer. Some techniques are implemented by distributing input torque on a driven axle of the motor vehicle. That is, torque from the motor vehicle engine is distributed between the left and right road wheels according to the needs of a particular situation.

For example, to reduce an understeer on a front-wheel drive motor vehicle, engine torque may be distributed between the left and right road wheels on the front axle. Similarly, to correct an understeer for a rear-wheel drive motor vehicle, engine torque may be distributed between the left and right road wheels on the rear axle. Likewise, distributing input torque between the left and right road wheels increases the performance and handling of the motor vehicle. While distribution of engine torque between the road wheels of an axle driven by the motor vehicle engine provides numerous benefits and improves the driving experience, other improvements in the driving experience are sought through modification of the torque differential between non-driven road wheels of the motor vehicle.

For example, it has been found that some users of front-wheel drive motor vehicles prefer the driving experience of a rear-wheel drive vehicle, while also desiring the benefits of a front-wheel drive motor vehicle. Because previous torque modification techniques were implemented by distributing input torque from the motor vehicle engine (i.e., were implemented on the driven axle), users that desired the benefits of a front-wheel drive vehicle were unable to enjoy the driving experience of a rear-wheel drive vehicle and receive other benefits and improvements to the driving experience provided by a driven axle configuration.

Accordingly, it is desirable to provide apparatus and methods for modifying the torque differential between road wheels of a non-driven axle. In addition, it is desirable to provide apparatus and methods for reducing the effects of an understeer situation in a front-wheel drive vehicle using the rear axle. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Various embodiments of the invention provide apparatus for modifying the torque differential between the road wheels of a non-driven axle. One apparatus comprises a first non-driven shaft, a second non-driven shaft, and a torque transfer modulator coupling the first non-driven shaft and the second non-driven shaft. The torque transfer modulator is configured to modify a torque differential between the first non-driven shaft and the second non-driven shaft.

Other embodiments of the invention provide a motor vehicle capable of modifying the torque differential between the road wheels of a non-driven axle. One motor vehicle comprises a left road wheel, a right road wheel, and a non-driven axle comprising a first torque transfer modulator coupling the left road wheel and the right road wheel. The first torque transfer modulator is configured to modify torque between the left road wheel and the right road wheel void of engine torque. One or more sensors configured to detect a left-turn understeer and/or a right-turn understeer is/are also included. The motor vehicle also comprises a controller in communication with the sensor and the first torque transfer modulator. The controller is configured to transmit an actuating signal to the first torque transfer modulator in response to left-turn or right-turn understeer, and the first torque transfer modulator is configured to distribute torque between the left road wheel and the right road wheel in response to receiving the actuating signal.

Various embodiments of the invention also provide methods for modifying the torque differential between the road wheels of a non-driven axle. One method comprises the steps of detecting a driving condition, subtracting an amount of torque from the first non-driven road wheel, and adding the amount of torque to the second non-driven road wheel in response to detecting the driving condition.

### BRIEF DESCRIPTION OF THE DRAWINGS

The present invention will hereinafter be described in conjunction with the following drawing figures, wherein like numerals denote like elements, and

FIG. 1 is a block diagram of a non-driven axle in accordance with an exemplary embodiment;

FIG. 2 is a schematic diagram of a torque transfer modulator (TTM) of FIG. 1 in accordance with an exemplary embodiment;

FIG. 3 is a diagram illustrating a configuration of the TTM of FIG. 2 when utilized to reduce an unstable condition in accordance with one exemplary embodiment;

FIG. 4 is a diagram illustrating a configuration of the TTM of FIG. 2 when utilized to reduce another unstable condition in accordance with an exemplary embodiment;

FIG. 5 is a diagram of one exemplary embodiment of a motor vehicle comprising the non-driven axle of FIG. 2; and

FIG. 6 is a flow diagram representing one exemplary embodiment of a method for modifying the torque differential between the road wheels of a non-driven axle.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

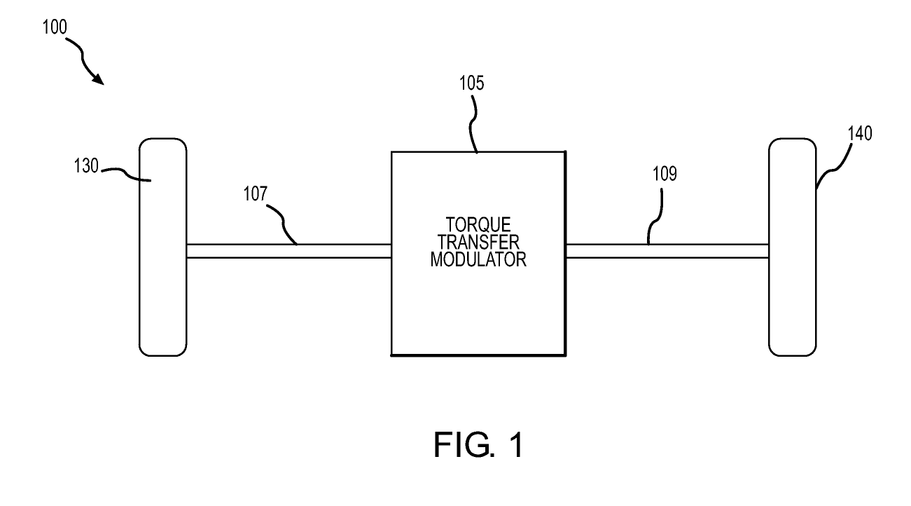

FIG. 1 is a block diagram of a non-driven axle 100 that does not receive input torque from a motor vehicle engine (herein after referred to as a non-driven axle) in accordance with one exemplary embodiment. Non-driven axle 100 comprises a torque transfer modulator (TTM) 105 coupling a left axle portion 107 and a right axle portion 109. Axle portions 107 and 109 couple non-driven axle 100 to road wheel mounts 130 and 140, respectively.

TTM 105 may be any device, structure, or mechanism capable of transferring/distributing torque from road wheel mount 130 to road wheel mount 140, or vice-versa, without torque input from, for example, an engine. That is, TTM 105 is anything capable of taking torque from (i.e., applying a negative torque to) road wheel mount 130 or road wheel mount 140 and distributing the torque (i.e., applying an equal and opposite (positive) amount of torque) to the other respective road wheel mount void of engine torque. For example, TTM 105 may be a mechanical system (e.g., wave gear, planetary gear set, lay shafts, etc.), a hydraulic system (e.g., servo-drive pump, hydraulic motor, etc.), an electrical system (e.g., an electric motor, etc.), and the like.

As one skilled in the art will appreciate, there are numerous techniques and devices capable of transferring torque between road wheel mount 130 and road wheel mount 140 without using engine torque, and the present invention contemplates each of these techniques. Therefore, the discussion below is not intended to limit the scope of the invention, but rather, is intended to disclose one of many devices and techniques capable of transferring torque between road wheel mount 130 and road wheel mount 140 void of engine torque.

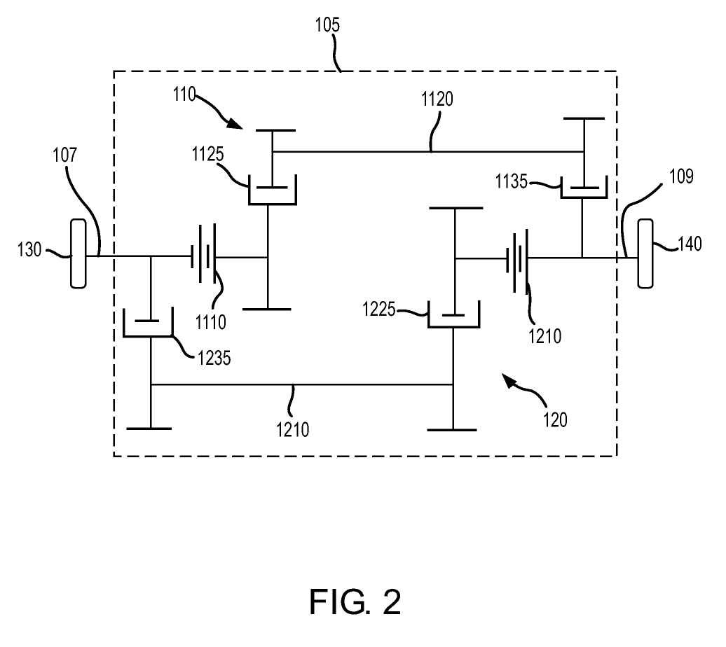

FIG. 2 is a schematic diagram of one exemplary embodiment of TTM 105. As illustrated, TTM 105 comprises an axle system 110 coupled to road wheel mount 140 via axle portion 109 and an axle system 120 coupled to road wheel mount 130 via axle portion 107.

In accordance with one exemplary embodiment, axle system 110 comprises a torque transferring device (TTD) 110 coupled to axle portion 107. TTD 110 may be, for example, a multi-plate wet clutch (e.g., magnetically actuated or hydraulic), a magneto-rheological (MR) fluid clutch, a motor-generator (e.g., hydraulic or electrical), or other torque transferring device capable of being engaged and disengaged. TTD 1110 is also coupled to a lay shaft 1120 via a gear 1125, and lay shaft 1120 is coupled to road wheel mount 140 via a gear 1135 and axle portion 109. Lay shaft 1120 and gears 1125, 1135 are well known in the art and are not discussed in detail herein. When engaged (released), TTD 1110 is configured to apply a negative torque to (i.e., take torque away from) road wheel mount 130 and apply a positive torque to (i.e., distribute an equal and opposite torque to) road wheel mount 140 via gear 1125, lay shaft 1120, and gear 1135.

As opposed to conventional torque distributing techniques, TTD 1110 distributes the torque from road wheel mount 130 to road wheel mount 140 without input torque (e.g., torque from an engine), while TTD 1210 (discussed below) is open. That is, TTD 1110 does not distribute engine torque between road wheel mounts 130 and 140, but rather, takes (or subtracts) torque from road wheel mount 130 and applies the taken (or subtracted) torque to road wheel mount 140.

Similarly, axle system 120 includes a TTD 1210 (similar to TTD 1110) coupled to axle portion 109. TTD 1210 is also coupled to a lay shaft 1220 via a gear 1225, and lay shaft 1220 is coupled to road wheel mount 140 via a gear 1235 and axle portion 107. When engaged (released), TTD 1210 is configured to apply a negative torque to (i.e., take torque away from) road wheel mount 140 and apply a positive torque to (i.e., distribute an equal and opposite torque to) road wheel mount 130 via gear 1225, lay shaft 1220, and gear 1235.

Similar to TTD 1110, TTD 1210 distributes the torque from road wheel mount 140 to road wheel mount 130 without input torque (e.g., torque from an engine), while TTD 1110 is open. That is, TTD 1210 does not distribute engine torque between road wheel mounts 130 and 140, but rather, takes (or subtracts) torque from road wheel mount 140 and applies the taken (or subtracted) torque to road wheel mount 130.

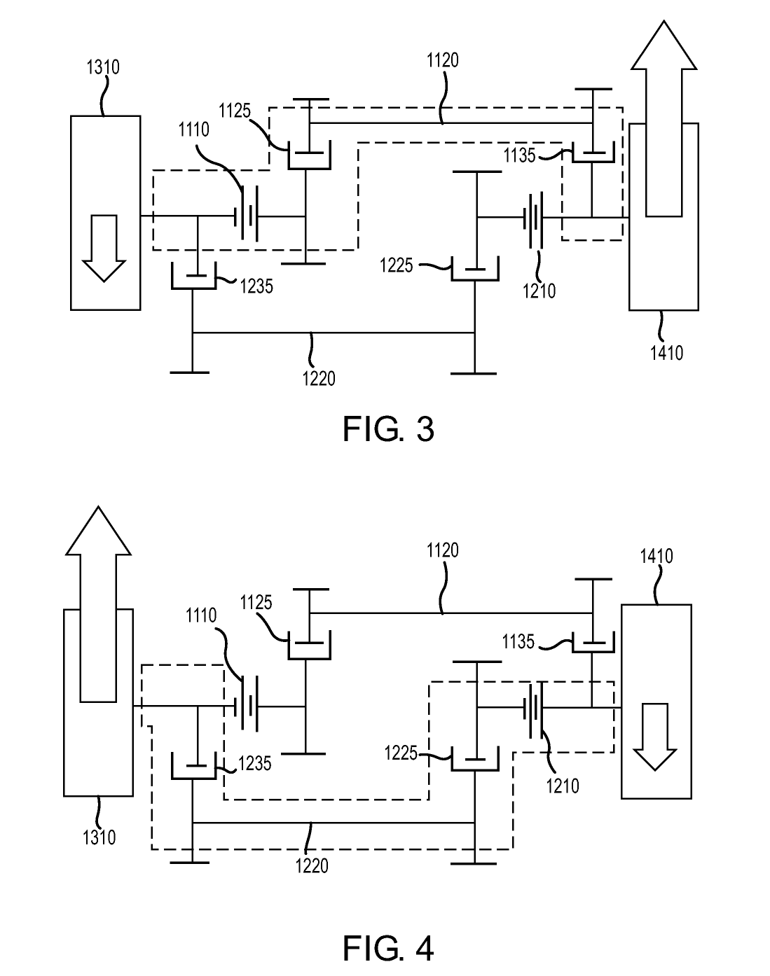

FIG. 3 is a diagram of non-driven axle 100 when utilized to reduce an unstable condition (e.g., a left-turn understeer, a non-linear range solution, etc.) and/or increase the performance envelop of the motor vehicle in accordance with one embodiment. Here, TTD 1110 has been engaged such that TTD 1110 applies a negative torque to a road wheel 1310 coupled to road wheel mount 130, and applies a positive torque to a road wheel 1410 coupled to road wheel mount 140 via gear 1125, lay shaft 1120, and gear 1135 (as indicated by the dashed lines surrounding TTD 110, gear 1125, lay shaft 1120, and gear 1135). One result of TTD 1110 applying a negative torque to road wheel 1310 and a positive torque to road wheel 1410 is to increase the torque differential between road wheels 1310 and 1410.

Note that TTD 1110 does not distribute engine torque between road wheels 1310 and 1410, but rather, is a speed-based system on a non-driven axle. That is, TTD 1110 takes an amount of torque from road wheel 1310 (i.e., brakes road wheel 1310) and applies an equal and opposite amount of torque to road wheel 1410 (i.e., accelerates road wheel 1410).

The amount of torque taken from road wheel 1310 and applied to road 1410 may be a fixed ratio (e.g., 0-30%) of the torque on road wheel 1310. For example, if road wheel 1310 is rotating at 1000 revolutions-per-minute (RPMs), TTD 1110 may be configured to subtract (or slow road wheel 1310 by) 250 RPMs (i.e., a fixed ratio of 25%) from road wheel 1310 and add (or accelerate road wheel 1410 by) 250 RPMs to road wheel 1410. Moreover, the amount of torque taken from road wheel 1310 and applied to road 1410 may be a variable ratio depending on the speed at which the motor vehicle is traveling.

FIG. 4 is a diagram of non-driven axle 100 when utilized to reduce another unstable condition (e.g., a right-turn understeer, non-linear range solution, etc.) and/or increase the performance envelop of the motor vehicle in accordance with one embodiment. Here, TTD 1210 has been engaged such that TTD 1210 applies a negative torque to a road wheel 1410 coupled to road wheel mount 140, and applies a positive torque to a road wheel 1310 coupled to road wheel mount 130 via gear 1225, lay shaft 1220, and gear 1235 (as indicated by the dashed lines surrounding TTD 1210, gear 1225, lay shaft 1220, and gear 1235). One result of TTD 1210 applying a negative torque to road wheel 1410 and a positive torque to road wheel 1310 is to increase the torque differential between road wheels 1310 and 1410.

Note that TTD 1210 does not distribute engine torque between road wheels 1310 and 1410, but rather, is a speed-based system on a non-driven axle. That is, TTD 1210 takes an amount of torque from road wheel 1410 (i.e., brakes road wheel 1410) and applies an equal and opposite amount of that torque to road wheel 1310 (i.e., accelerates road wheel 1310).

The amount of torque taken from road wheel 1410 and applied to road 1310 may be a fixed ratio (e.g., 0-30%) of the torque on road wheel 1410. Moreover, the amount of torque taken from road wheel 1410 and applied to road 1310 may be a variable ratio depending on the speed at which the motor vehicle is traveling. For example, when the motor vehicle is traveling less than 25 miles-per-hour (mph), TTD 1210 may be configured to subtract (or slow road wheel 1410 by) 30% of the torque from road wheel 1410 and add (or accelerate road wheel 1310 by) that 30% to road wheel 1310. Furthermore, TTD 1210 may be configured to subtract (or slow road wheel 1410) 20% of the torque from road wheel 1410 and add (or accelerate road wheel 1310 by) the 20% of torque to road wheel 1310 when the motor vehicle is traveling between 25 mph and 50 mph. Furthermore, TTD 1210 may be configured to subtract (or slow road wheel 1410) 10% of the torque from road wheel 1410 and add (or accelerate road wheel 1310 by) the 10% to road wheel 1310 when the motor vehicle is traveling greater than 50 mph.

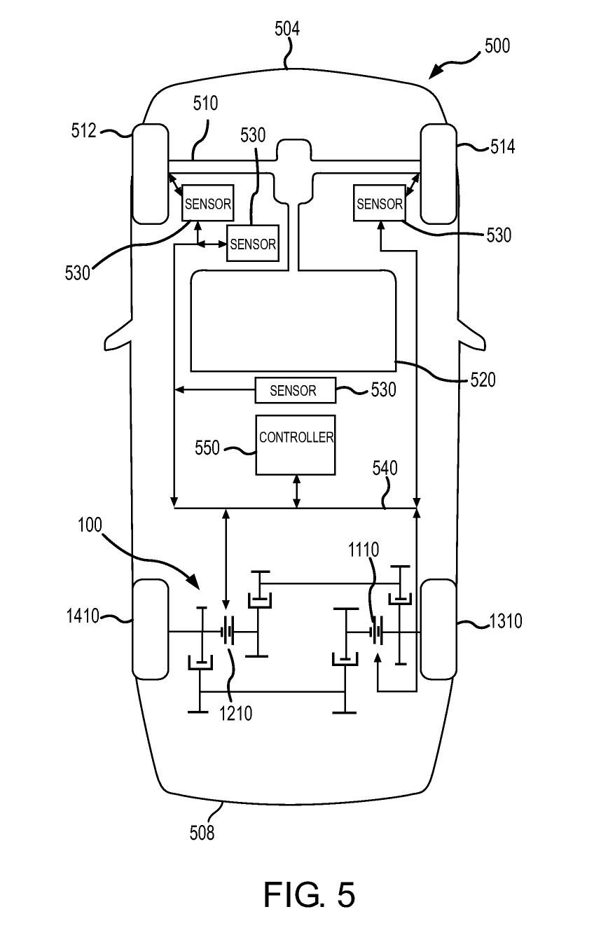

FIG. 5 is a diagram of one exemplary embodiment of a motor vehicle (e.g., an automobile, truck, etc.) 500 comprising non-driven axle 100. Motor vehicle 500 comprises a driven axle 510 (i.e., an axle that receives input or engine torque) coupled to and configured to provide engine torque to road wheels 512 and 514 via respective road wheel mounts (not shown). Driven axle 510 is coupled to, and driven by, a power plant (e.g., an electric engine, combustion engine, a hybrid engine, and the like) 520. Notably, power plant 520 does not drive non-driven axle 100.

In one embodiment, motor vehicle 500 is a front-wheel drive automobile such that driven axle 510 is located toward a front 504 and non-driven axle 100 is located toward a rear 508 of motor vehicle 500. In another embodiment (not shown), motor vehicle 500 is a rear-wheel drive automobile such that non-driven axle 100 is located toward front 504 and driven axle 510 is located toward rear 508 of motor vehicle 500.

Motor vehicle 500 suitably includes at least one sensor 530 coupled to road wheel 512 and/or road wheel 514 of driven axle 510, and in communication with a controller 550 via a bus 540 (e.g., an electrical bus, optical bus, and the like). Sensor(s) 530 are configured to detect an unstable condition (e.g., a right-turn understeer, a left-turn understeer situation, non-linear range solution, etc.) and transmit a message to controller 550 via bus 540 indicating the type of unstable condition or a stable condition. Sensor(s) 530 may be located anywhere on motor vehicle 500 that would enable sensor(s) 530 to detect a right-turn understeer and/or a left-turn understeer situation.

Controller 550 is coupled to each of TTD 1110 and TTD 1210 via bus 540. Controller 550 is configured to receive messages from sensor(s) 530 and engage TTD 1110 or TTD 1210 depending upon whether the unstable condition is, for example, a left-turn or right-turn understeer situation. That is, controller 550 is configured to engage TTD 1110 or TTD 1210 to increase the torque differential between road wheels 1310 and 1410 (i.e., apply a negative torque to one of road wheels 1310 and 1410 and apply an equal amount of positive torque to the other respective road wheel).

For example, when motor vehicle 500 is experiencing a right-turn understeer, sensor(s) 530 detects that motor vehicle 500 is experiencing the right-turn understeer and communicates such to controller 550. Controller 550 then engages TTD 1210, which results in torque being taken from (i.e., a negative torque applied to) road wheel 1410 (i.e., the inside road wheel) and an equal amount of torque being applied (i.e., positive torque) to road wheel 1310 (i.e., the outside road wheel). The opposite is the situation when motor vehicle 500 is experiencing a left-turn understeer—controller 550 engages TTD 1110, which results in torque being taken from (i.e., a negative torque applied to) road wheel 1310 (i.e., the inside road wheel) and an equal amount of torque being applied (i.e., positive torque) to road wheel 1410 (i.e., the outside road wheel).

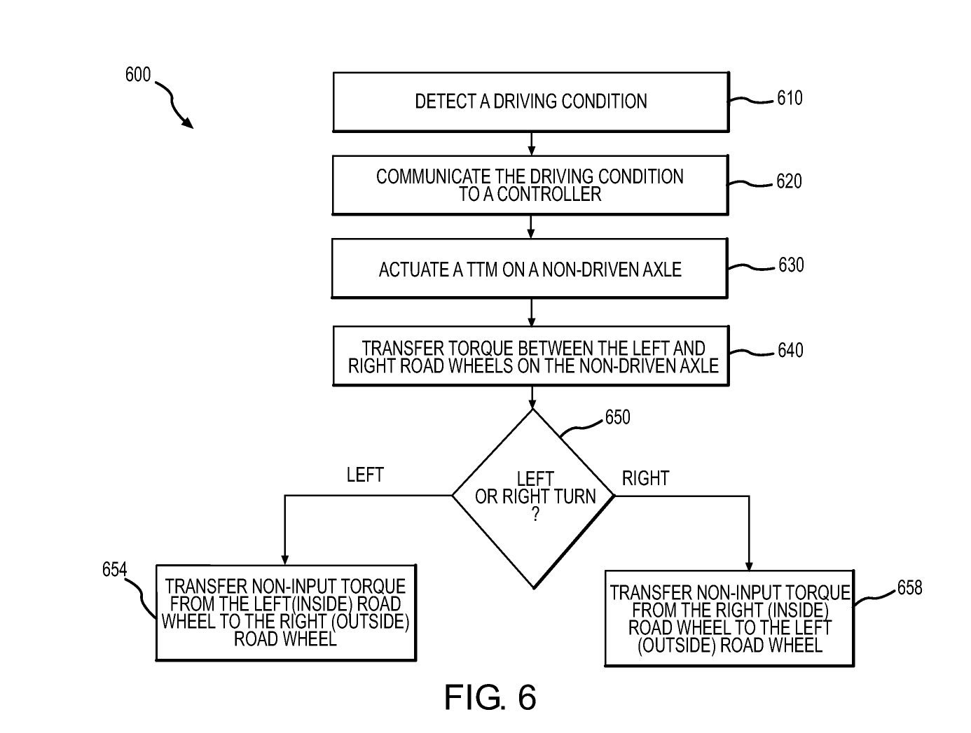

FIG. 6 is a flow diagram representing an exemplary method 600 for modifying the torque differential between the road wheels of a non-driven axle (e.g., non-driven axle 100). Method 600 begins when at least one sensor (e.g., sensor 530) detects a driving condition (e.g., a right turn, a left turn, right-turn understeer, or a left-turn understeer) (step 610), and communicates such to a controller (e.g., controller 550) (step 620).

Controller 550 then actuates a TTM (e.g., TTM 105) on non-driven axle 100 (step 630). When actuated, TTM 105 transfers torque between the left and right road wheels (e.g., roadwheel 1310 and 1410, respectively) (step 640).

The amount of torque transferred between road wheels 1310 and 1410 may be either a fixed ratio (e.g., 0-30%) or a variable ratio depending upon the speed of the motor vehicle and/or the severity of the driving condition (e.g., an understeer) as discussed above with reference to FIGS. 3 and 4, respectively. The severity of, for example, an understeer may be determined by the angle of the steering wheel in relation to the angle the motor vehicle is traveling and/or by comparing the actual yaw rate to a pre-determined/model yaw rate for the motor vehicle.

When a turn is detected, whether TTM 105 transfers torque from road wheel 1310 to road wheel 1410 or from road wheel 1410 to road wheel 1310 depends on if a left turn or a right turn is detected (step 650). In either situation, TTM 105 distributes non-input torque from the inside road wheel to the outside road wheel (i.e., reacts the left and right road wheels against one another). That is, non-engine torque is transferred from the left road wheel (i.e., road wheel 1310) to the right road wheel (i.e., road wheel 1410) for left turns (step 654), and non-engine torque is transferred from the right road wheel (i.e., road wheel 1410) to the left road wheel (i.e., road wheel 1310) for right turns (step 658). For example, torque is shifted from the left road wheel to the right road wheel to correct a left-turn understeer and/or to increase the performance of the motor vehicle when turning left, and torque is shifted from the right road wheel to the left road wheel to correct a right-turn understeer and/or to increase the performance of the motor vehicle when turning right.

In one exemplary embodiment, TTM 105 uses a TTD (e.g., TTD 1110 or TTD 1210) to correct a right-turn or left-turn understeer, and/or to increase performance when the motor vehicle is turning left or right. For example, TTD 1110 is actuated to correct a left-turn understeer and/or increase left-turn performance by transferring torque from road wheel 1310 (i.e., the inside road wheel) to road wheel 1410 (i.e., the outside road wheel), and TTD 1210 is actuated to correct a right-turn understeer and/or increase right-turn performance by transferring torque from road wheel 1410 to road wheel 1310. That is, an understeer may be corrected or performance may be increased by braking (i.e., applying a negative torque, slowing down rotation, holding against rotation, etc.) the inside wheel and transferring the torque (i.e., applying a positive torque, speeding up rotation, releasing rotation, etc.) to the outside wheel (in an equal amount) void of input/engine torque. Other embodiments of the invention contemplate the use of other devices and/or techniques for transferring non-input torque between road wheels 1310 and 1410.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

We claim:

1. A motor vehicle axle, comprising:
a first non-driven shaft;
a second non-driven shaft; and
a first torque transfer modulator coupling the first non-driven shaft and the second non-driven shaft, the first torque transfer modulator configured to modify a torque differential between the first non-driven shaft and the second non-driven shaft.

2. The motor vehicle axle of claim 1, wherein the non-driven axle is a rear axle of the motor vehicle.

3. The motor vehicle axle of claim 1, wherein the first torque transfer modulator is configured to modify the torque differential between the first non-driven shaft and the second non-driven shaft in response to an understeer situation.

4. The motor vehicle axle of claim 3, wherein the first torque transfer modulator is configured to brake the first non-driven shaft and accelerate the second non-driven shaft to correct a left-turn understeer.

5. The motor vehicle axle of claim 3, wherein the first torque transfer modulator is configured to brake the second non-driven shaft and accelerate the first non-driven shaft to correct a right-turn understeer.

6. The motor vehicle axle of claim 1, wherein the non-driven axle further comprises:
a second torque transfer modulator coupling the first non-driven shaft and the second non-driven shaft, and configured to modify a torque differential between the first non-driven shaft and the second non-driven shaft, wherein:
the first torque transfer modulator is configured to distribute torque from the first non-driven shaft to the second non-driven shaft, and
the second torque transfer modulator is configured to distribute torque from the second non-driven shaft to the first non-driven shaft.

7. The motor vehicle axle of claim 6, wherein the non-driven axle further comprises:
a first lay shaft coupling the first torque transfer modulator to the second non-driven shaft, the first torque transfer modulator configured to modify a first rate of spin of the first lay shaft in transferring torque from the first non-driven shaft to the second non-driven shaft; and
a second lay shaft coupling the second torque transfer modulator to the first non-driven shaft, the second torque transfer modulator configured to modify a second rate of spin of the second lay shaft in distributing torque from the second non-driven shaft to the first non-driven shaft.

8. The motor vehicle axle of claim 1, wherein the first torque transfer modulator comprises one of a magnetically actuated multi-plate wet clutch, a hydraulic multi-plate wet clutch, a magneto-rheological fluid clutch, a hydraulic motor-generator, and an electrical motor-generator.

9. A motor vehicle, comprising:
a left road wheel;
a right road wheel;
a non-driven axle including a first torque transfer modulator coupling the left road wheel and the right road wheel, the first torque transfer modulator configured to modify torque between the left road wheel and the right road wheel void of engine torque;
a sensor configured to detect one of a left turn and a right turn; and
a controller in communication with the sensor and the first torque transfer modulator, wherein the controller is configured to transmit an actuating signal to the first torque transfer modulator in response to the one of the left-turn and the right-turn, and the first torque transfer modulator is configured to distribute torque between the left road wheel and the right road wheel in response to receiving the actuating signal.

10. The motor vehicle of claim 9, wherein the controller is configured to actuate the first torque transfer modulator to apply a positive torque to the left road wheel and apply a negative torque to the right road wheel when a right-turn understeer situation is detected.

11. The motor vehicle of claim 9, wherein the controller is configured to actuate the first torque transfer modulator to apply a positive torque to the right road wheel and apply a negative torque to the left road wheel when a left-turn understeer situation is detected.

12. The motor vehicle of claim 9, further comprising a driven axle, wherein the driven axle is a front axle and the non-driven axle is a rear axle of the motor vehicle.

13. The motor vehicle of claim 9, further comprising a driven axle, wherein the driven axle is a rear axle and the non-driven axle is a front axle of the motor vehicle.

14. A method for stabilizing a motor vehicle comprising an axle coupling a first non-driven road wheel and a second non-driven road wheel, the method comprising the steps of:
detecting a driving condition;
subtracting an amount of torque from the first non-driven road wheel; and
adding the amount of torque to the second non-driven road wheel in response to detecting the driving condition.

15. The method of claim 14, wherein the driving condition is one of a left understeer and a right understeer.

16. The method of claim 14, wherein the adding step and the subtracting step occur on a rear axle of the motor vehicle.

17. The method of claim 14, wherein the adding step and the subtracting step occur on a front axle of the motor vehicle.

18. The method of claim 14, wherein the subtracting step comprises the step of subtracting the amount of torque from a non-driven, left road wheel and the adding step comprises the step of adding the amount of torque to a non-driven, right road wheel.

19. The method of claim 14, wherein the subtracting step comprises the step of subtracting the amount of torque from a non-driven, right road wheel and the adding step comprises the step of adding the amount of torque to a non-driven, left road wheel.

20. The method of claim 14, wherein the amount of torque is in the range of about 1% to about 30% of torque on the first non-driven road wheel. _
